(19) United States
(12) Patent Application Publication
(10) Pub. No.: US 2015/0312668 A1
(43) Pub. Date: Oct. 29, 2015

(54) HEADPHONE WIRE CLASP APPARATUS

(71) Applicant: DUBGEAR INC., Etobicoke (CA)

(72) Inventors: Jansen Leslie WHITE, Etobicoke (CA); Jonathan Paul LOUDON, Toronto (CA); Rebecca BRUNETTE, Toronto (CA); John Paul SCHMIDER, Etobicoke (CA); Allan MALTAIS, Sharon (CA)

(21) Appl. No.: 14/638,182

(22) Filed: Mar. 4, 2015

Related U.S. Application Data
(60) Provisional application No. 61/948,300, filed on Mar. 5, 2014.

(51) Int. Cl. H04R 1/10

(52) U.S. Cl. CPC H04R 1/1033

(57) ABSTRACT

A headphone apparatus. The apparatus includes a clasp and a pendant. The clasp has a left portion and a right portion that are removably engageable to one another. Each of the portions has a channel for securing a respective wire of the headphones. The pair of channels have terminating ends extending in opposing directions. The pendant has two opposing apertures corresponding to left and right headphone wires.

### TECHNICAL FIELD

The following relates generally to an audio headphone wiring harness and more specifically to a headphone wire clasp apparatus.

### BACKGROUND

It is well known that ownership of smartphones and mobile audio devices is pervasive. Many users of these devices utilize their devices, at times, through the use of headphone apparatus. Many such headphones, indeed those often provided by the manufacturer of the device, are earbud style headphones.

Three issues that exist for earbud headphones are (1) their tendency to fall out of the wearer's ear due to movement and vibration, (2) the lack of suitable temporary storage when the earbud is not in use, and (3) the general untidiness, or unruliness, of the wires that lead from the earbud to the device, which is apparent for any wearer as the wires tend to coil and cross over one another several times as they traverse the wearer's body.

The second issue is apparent for a wearer that encounters a real-life interaction with another person. In most cases, the wearer must remove the earbud from one or both ears, for either functional (the need to hear the other person) or cultural (the need to be polite) reasons. If the wearer removes one earbud, it might dangle and collide with other objects or interfere with the wearer in other ways. If the wearer removes both earbuds, then the wearer typically has to either hold the earbuds or allow them to fall to the floor, which poses a cleanliness and breakage hazard.

Various devices have been proposed to alleviate this concern. One such device is the li Earphones Snap Strap™, which is an elongate flexible strap terminating at two engagement locations. The engagement locations have clips that engage the left and right wires of the earbuds at a location approximately 4 to 8 inches directly below the ears, which is around the height of the wearer's neck. During use, the wearer lifts the Snap Strap over her head and places it behind her neck. When one or both earbuds are removed, they dangle from the Snap Strap.

Another device is the Zipi™. It is similar to the Snap Strap but has a pair of magnets disposed half way along the strap, allowing the wearer to place and remove the strap without having to lift it over her head.

### SUMMARY

In one aspect, a clasp for a pair of headphones is provided, the clasp comprising a left portion and a right portion removably engageable to one another, each of the portions retaining a respective wire of the headphones, each wire extending in opposing directions from the clasp.

In another aspect, a pendant for a pair of headphones is provided, the pendant having two opposing apertures corresponding to left and right headphone wires

In yet another aspect, a headphone apparatus is provided, the headphone apparatus comprising: a clasp, the clasp comprising a left portion and a right portion removably engageable to one another, each of the portions retaining a respective wire of the headphones, each wire extending in opposing directions from the clasp; and a pendant, the pendant having two opposing apertures corresponding to left and right headphone wires.

### DESCRIPTION OF THE DRAWINGS

The features of the invention will become more apparent in the following detailed description in which reference is made to the appended drawings wherein:

FIG. 1 is a front perspective view of the headphone apparatus;

FIG. 2 is a front perspective view and rear perspective view of the headphone apparatus shown being worn by a wearer;

FIG. 3 is several views of a pendant;

FIG. 4 is an exploded view of a pendant enclosure;

FIG. 5 is a front view of a clasp;

FIG. 6 is several views of the clasp;

FIG. 7 is a front perspective view of another embodiment of the headphone apparatus;

FIG. 8 is a front perspective view of another embodiment of the pendant;

FIG. 9 is several views of an embodiment of the headphone apparatus;

FIG. 10 is a close-up view of a pendant and headphones of the headphone apparatus shown in FIG. 9;

FIG. 11 is a close-up view of a clasp of the headphone apparatus shown in FIG. 9; and

FIG. 12 is a close-up front view of the pendant of the headphone apparatus shown in FIG. 9

### DETAILED DESCRIPTION

Embodiments will now be described with reference to the figures. It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

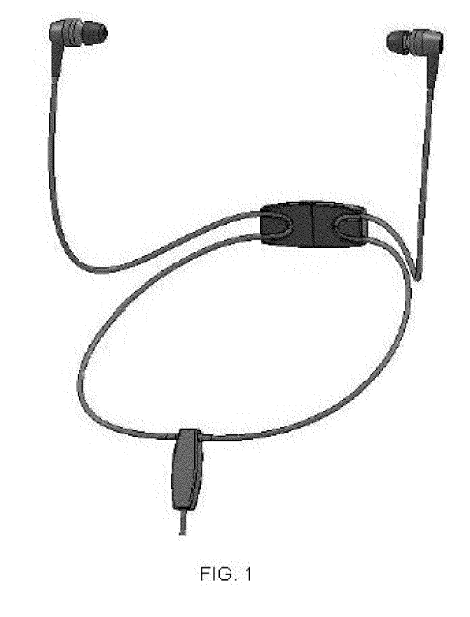

Referring now to FIG. 1, a headphone wire clasp apparatus (100) is provided. The apparatus (100) comprises a pendant (102) and a clasp (104). When the headphones are in use by a wearer, the pendant (102) will typically be disposed near the wearer's chest or between the chest and neck, while the clasp (1040 will typically be disposed along the back of the wearer's neck. The apparatus (100) may further comprise wiring (106) terminating at a pair of headphones (108), which are shown as earbuds but could be another suitable headphone form factor.

Referring now to FIG. 3, the pendant is an enclosure having at least two apertures (300, 302), a left and a right aperture, disposed therethough. The enclosure may, in certain embodiments, further comprise a bottom aperture (304). The enclosure will generally house electronic components enabling audio transmission from an audio device to the headphones for listening by a wearer of the headphones.

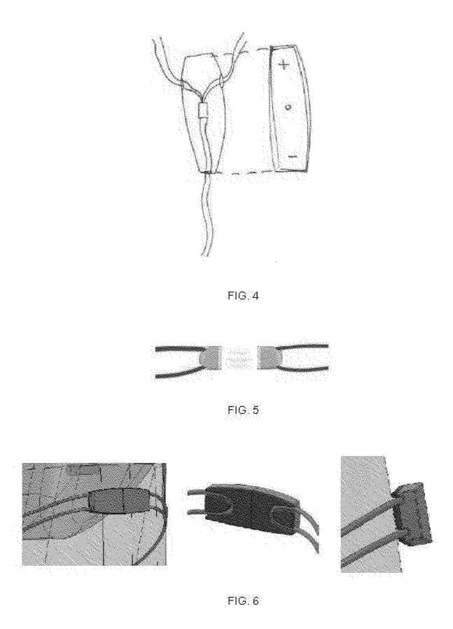

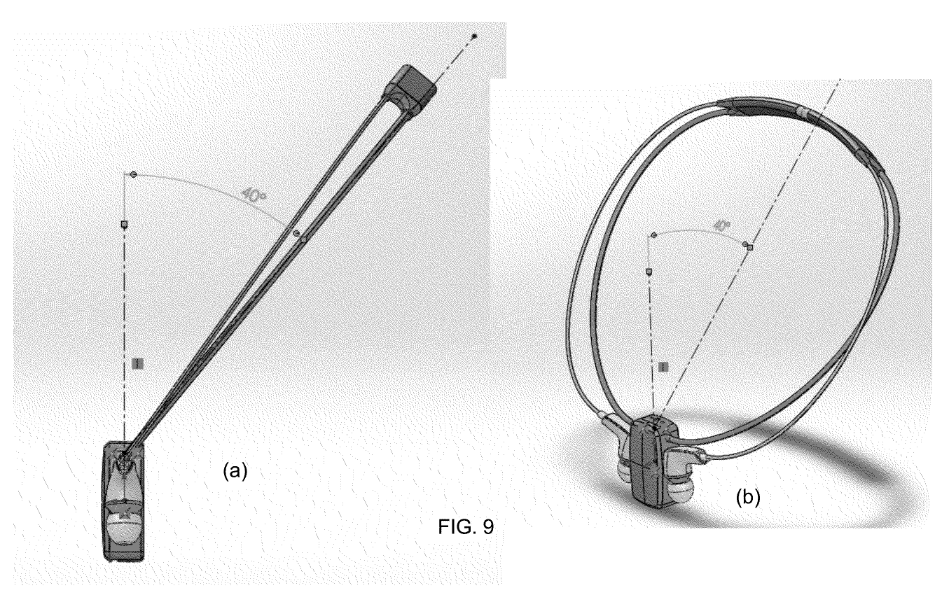

Referring now to FIG. 4, in certain embodiments, the pendant (102) is essentially a hollow housing (400). It may be provided as an aftermarket accessory permitting a user to affix it onto existing headphone wiring. For example, the pendant may comprise two halves (402, 404) which are affixed together via a snap fit mechanism or other suitable fastener, as are known in the art. Most headphone wiring (406) comprises a single-wire portion (408) (wherein it is understood that the “single-wire” refers to how a consumer would view the wire; the “single-wire” actually contains several electrically isolated wires therein) and a split-wire portion (410) wherein the single-wire portion contains both left and right headphone wires (and any control or microphone wires) while the split-wire portion separates the left from the right headphone wires (and could either have a third wire for a controller and/or microphone or integrates the controller or microphone onto the left or right wire). In use, the user would enclose the wire such that the single-wire portion (408) extends from the bottom aperture while the split-wires (410) extend from the left and right apertures (300, 302). The wire could either be a soft flexible wire or a rigid wire. Similarly, if the wire is a rigid wire, it could be affixed to the pendant at either a fixed or moveable angle. A fixed angle of approximately 40 degrees, as an example, provides an aesthetic effect that the pendant might resemble a necklace when worn by a user, as shown in FIG. 9

In certain other embodiments, the pendant (102) comprises an electronic device which is a controller (412) in electronic communication with an audio device. In some of these embodiments, the controller is disposed along the headphone wire. Preferably, a single-wire electronically couples the controller to the audio device, and a left and right split-wire combination extends from opposing sides of the pendant device. The controller may comprise one or more command buttons or switches, or a touch-enabled control panel. As shown in FIG. 4, the controller has a + button (414) (e.g., next track or volume up),—button (416) (e.g., previous track or volume down) and 0 button (418) (e.g., pause, play, place or answer phone call, or other function).

Referring now to FIG. 7, in other of these embodiments, the pendant further comprises a wireless communication device, such as a Bluetooth™ transceiver, wirelessly coupled to an audio device to receive audio signals therefrom and transmit control signals thereto. In this case, the single wire to the audio device can be omitted, as can the bottom aperture of the pendant device. In these embodiments, it will be appreciated that the pendant may appear to an observer as a fashionable necklace pendant.

Referring now to FIG. 8, similar to the foregoing embodiment, the pendant may further comprise a female socket (800), preferably along its bottom edge (802), adapted to receive an intermediate headphone wire (804) with male plug (806), connecting the pendant to an audio device. In this way, when the wearer wishes to not listen to audio, the wearer can remove the wire from the pendant such that the pendant may appear to an observer as a fashionable necklace pendant. The bottom edge socket could alternatively be a charging socket to charge an integrated battery. The charging socket in this case could be micro-USB, as an example.

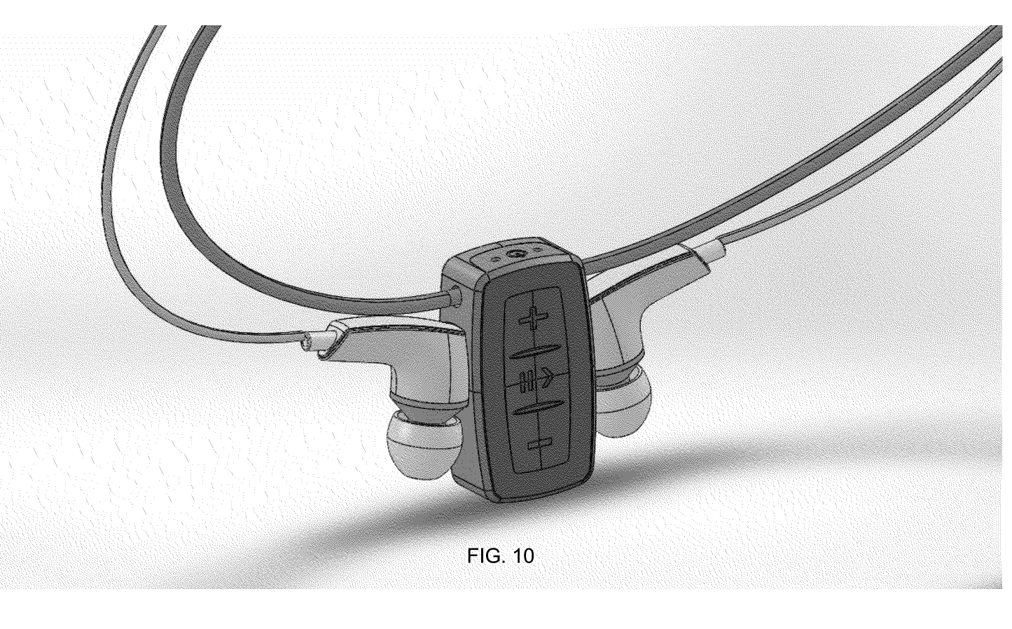

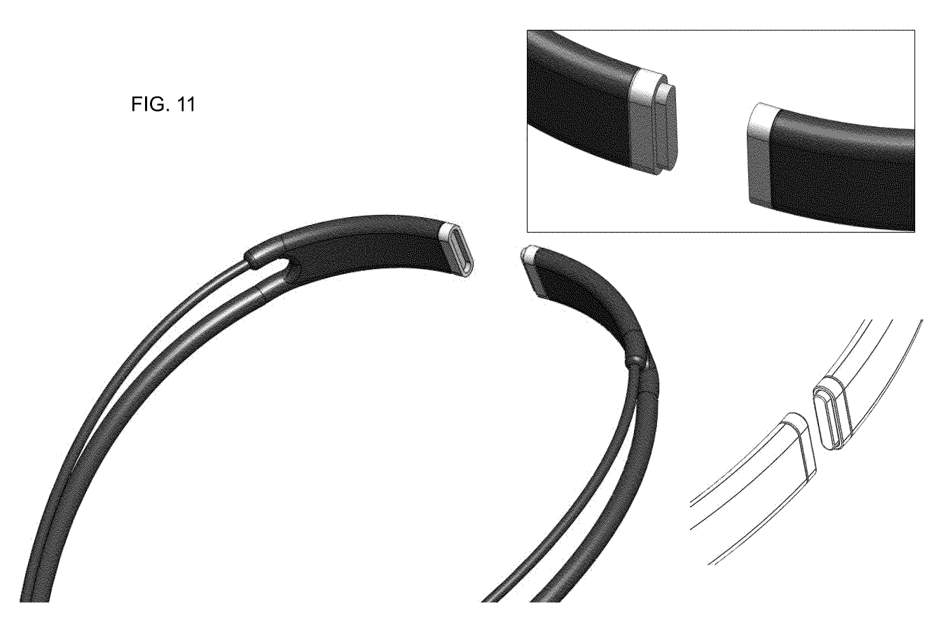

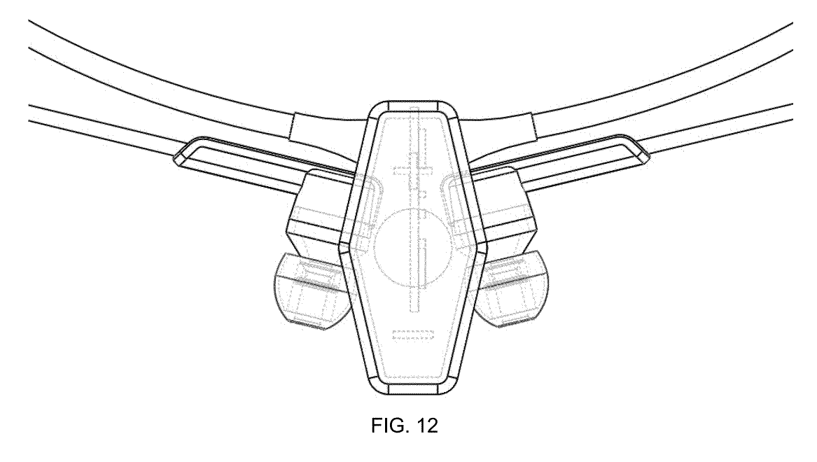

Referring now to FIG. 10, the pendant may further comprise a pair of fasteners disposed along its periphery that cooperate with fasteners disclosed upon the earbuds to provide a storage mechanism for the earbuds. As illustrated, for example, two opposing side surfaces of the pendant comprise magnets or a metallic surface, and the upper surface of each earbud comprises a complementary metallic surface or magnet, such that the each earbud can be removably fastened to the pendant when not in use. The pendant may additionally have recessed side surfaces that are dimensioned to accommodate the earbuds or a portion thereof, as shown in FIG. 12.

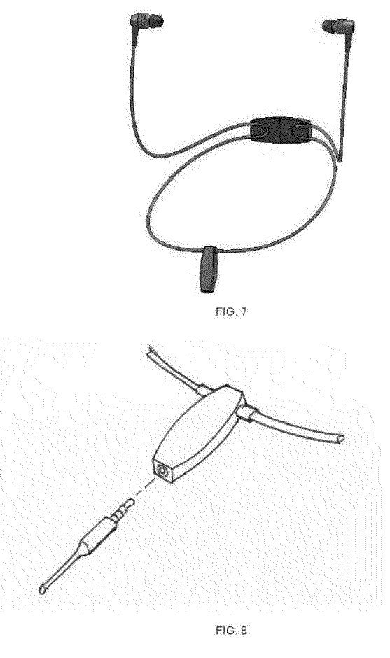

Referring now to FIG. 5, the clasp comprises a left portion (500) and a right portion (502) which can be removably engaged to one another. In an embodiment, each portion comprises a complementary magnetic surface for affixing to one another, though other fasteners such as Velcro or the like could be used. As shown in FIG. 11, the left and right portions (500, 502) may have abutting surfaces with complementary contours. For example, one of the surfaces may have a protrusion (1100) that is a close fit within a recess (1102) of the other surface.

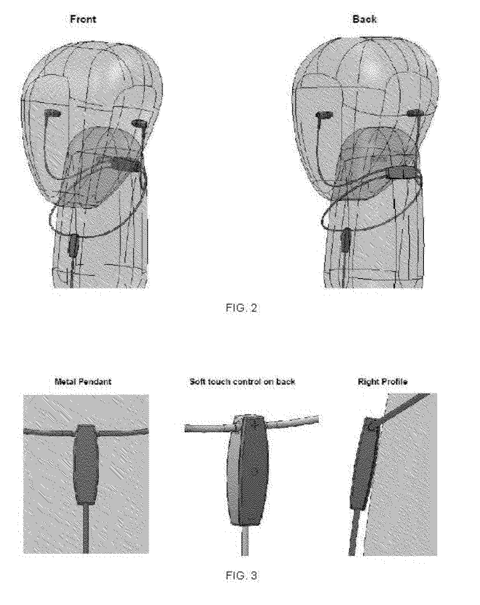

As shown in FIG. 2, when in use, the wearer typically places the left and right portions in contact behind her neck. While not in use, either the headphones dangle from the clasp device affixed behind her neck, or she may separate the clasp portions to store the headphones.

Referring now to FIG. 6, the left portion and the right portion correspond to left and right wires of the headphones, respectively. A channel (600), which is shown as a curved channel but may be another shape, is formed along a surface of each portion. The channel provides a removable engagement mechanism area for securely but removably affixing a portion of headphone wire (602). The removable engagement mechanism may, for example, be press-fit, friction fit, adhesive, or other suitable mechanism.

Preferably, the channel is formed along the inner surface (the surface that will abut the wearer's neck during use) for aesthetic reasons. The wearer can select the position along the headphone wire at which it is engaged within the channel. Typically, the wearer will provide for enough wire between the headphone (e.g., earbud) and back of the neck, plus some slack. Of course, since the channel provides a press-fit, the wire can be removed by the wearer and repositioned by the wearer as desired.

Preferably, as shown in FIG. 6, the channel has both its terminating ends along the left and right outer edges of the clasp. That is, the left headphone wire both enters and exits the channel on the left side of the clasp, and the right headphone wire both enters and exits the channel on the right side of the clasp.

Referring now to FIG. 2, when combined with the pendant, which has left and right apertures, the effect achieved by the described apparatus is to more cleanly separate the wires for the left and right headphones and for the headphone wiring to closely resemble a fashionable item of jewelry. Further, the pendant is less prone to flip around during use, as it is at all times being pulled to its natural state by the opposing forces of the left and right wires. It will be appreciated that this is not as easily achieved if the wires exited the pendant device from its top, nor if the wires went directly from the pendant device to the ears without looping behind the wearer's neck

To further increase aesthetic value, the pendant device may further comprise an interchangeable fascia. The fascia could be provided as a portion of the snap-fit housing or an additional face which can be fastened to the pendant device by a magnet, adhesive, snap mechanism, Velcro, or other fastener.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

We claim:

1. A clasp for a pair of headphones, the clasp comprising a left portion and a right portion removably engageable to one another, each of the portions retaining a respective wire of the headphones, each wire extending in opposing directions from the clasp.

2. The clasp of claim 1, wherein the left portion and the right portion comprise abutting surfaces fastenable to one another by complimentary fasteners.

3. The clasp of claim 2, wherein the complementary fasteners are cooperating magnets.

4. The clasp of claim 2, wherein the complementary fasteners comprise complementary contours.

5. The clasp of claim 1, wherein the length of the wire between the headphone and the clasp is slightly greater than the distance from a wearer's ear to back of the wearer's neck.

6. The clasp of claim 1, wherein each of the left portion and right portion comprise a channel for removable engaging the wire.

7. The clasp of claim 6, wherein the wire is retained within the channel by a press fit.

8. A pendant for a pair of headphones, the pendant having two opposing apertures corresponding to left and right headphone wires.

9. The pendant of claim 8, wherein the pendant biases the wires away from one another.

10. The pendant of claim 8, further comprising a bottom aperture accommodating a wire connectable to an audio device.

11. The pendant of claim 8, further comprising fasteners disposed on opposing surfaces thereof, each fastener cooperating with one of the headphones for removably engaging thereto.

12. The pendant of claim 8, further comprising an audio device controller housed therein.

13. A headphone apparatus comprising:
a. a clasp, the clasp comprising a left portion and a right portion removably engageable to one another, each of the portions retaining a respective wire of the headphones, each wire extending in opposing directions from the clasp; and
b. a pendant, the pendant having two opposing apertures corresponding to left and right headphone wires.
